(19) United States
(12) Patent Application Publication
(10) Pub. No.: US 2021/0122332 A1
(43) Pub. Date: Apr. 29, 2021

(54) SYSTEM FOR PROVIDING VEHICLE SECURITY, MONITORING AND ALERTING

(71) Applicant: PETER COOPER, Bethlehem, PA (US)

(72) Inventor: PETER COOPER, Bethlehem, PA (US)

(21) Appl. No.: 17/077,417

(22) Filed: Oct. 22, 2020

Related U.S. Application Data
(60) Provisional application No. 62/925,000, filed on Oct. 23, 2019.

(51) Int. Cl. B60R 25/102; B60R 25/30

(52) U.S. Cl. CPC B60R 25/102; B60R 2025/1016; B60R 25/305

(57) ABSTRACT

Disclosed is a vehicle security system for alerting on identifying an intrusion by an intruder. The vehicle security system includes at least one camera, a memory unit, a processing unit, a distributed set of databases, a server, an output device and a bi-directional communication unit. The camera is attached to the vehicle and is configured to capture images. The memory unit stores images captured by the camera. The processing unit is operably connected to the camera to process the images. The distributed set of databases for storing images and details of people. The server is operably connected to the processing unit, the distributed set of databases and stores authorized person images and a plurality of modules. The output device is operably connected to the processing unit to produce output signals on detecting the intruder. The plurality of modules includes an intruder module generates intruder signal by activating the output device to generate output signals and a personalized warning module activates the output device to generate personalized warning to warn off the intruder to stay away from the vehicle.

### CROSS-REFERENCE TO RELATED APPLICATION

This application claims the benefit of U.S. Provisional Patent Application No. 62/925,000, filed on Oct. 23, 2020, the disclosure of which is incorporated herein by reference.

### BACKGROUND OF THE INVENTION

### 1. Field of the Invention

The present invention generally relates to a system for providing vehicle security, but more particularly relates to a system for providing vehicle security, monitoring and alerting using facial recognition.

### 2. Description of Related Art

Vehicle security is a multimillion dollar industry. Many different theft deterrent devices have been developed over the years to prevent vehicle theft. Many new vehicles come fitted with a sophisticated vehicle alarm system, immobilizer and/or GPS tracking unit. However, despite the inclusion of these devices and systems in vehicles, a large number of vehicles are still being stolen annually.

There are various methods of prevention to reduce the likelihood of a vehicle getting stolen. These include physical barriers, which make the effort of stealing the vehicle more difficult. Some of these include devices used to lock a part of the vehicle necessary in its operation, such as the wheel, steering wheel or brake pedal. Others include alarm system that are triggered by breaking and entry into the vehicle, microdot identification tags that allow individual parts of a vehicle to be identified, and signs on the vehicle windows warning of other deterrents, sometimes as a bluff.

Vehicle theft syndicates have found ways of breaking into vehicles and bypassing or disabling existing vehicle alarm systems within minutes. In some instances, the thieves carry a portable supplementary electronic control unit and remote with them, specific to the vehicle being targeted, which allows them to disconnect and bypass the vehicle's existing alarm/immobilizer system which is ordinarily accessible from the vehicle cabin. This means that they can quickly and relatively easily gain entry to the vehicle and bypass the existing vehicle alarm/immobilizer system by connecting the supplementary electronic control unit and drive off within minutes, minimizing the possibility of being caught in the act.

Therefore, there is a need of a vehicle security system for alerting on identifying an intrusion. Further, the vehicle security system identifies intruder using image recognition and furthermore generates personalized warning messages to warn off the intruder. Further, the vehicle security system should create a network with other available system to alert other users and notify the owner of the vehicle.

### SUMMARY OF THE INVENTION

In accordance with teachings of the present invention, a vehicle security system for alerting on identifying an intrusion by an intruder is provided.

An object of the present invention is to provide a vehicle security system for alerting on identifying an intrusion by an intruder. The vehicle security system includes at least one camera, a memory unit, a processing unit, a distributed set of databases, a server, an output device and a bi-directional communication unit.

The camera is attached to the vehicle and is configured to capture images. The memory unit stores images captured by the camera. The processing unit is operably connected to the camera to process the images. The distributed set of databases for storing images and details of people. The server is operably connected to the processing unit, the distributed set of databases. The server further stores authorized person images and a plurality of modules.

The output device is operably connected to the processing unit to produce output signals on detecting the intruder. The bi-directional communication unit is operably connected to the processing unit to communicate processed images over a communication network. Further, the bi-directional communication unit receives commands from the server.

The plurality of modules includes a registration module for registering images of person authorized to access the vehicle and for registering vehicles, a verification module compares the images of the intruder with the registered images, an intruder module generates intruder signal by activating the output device to generate output signals if the intruder is not one of the registered person, and a personalized warning module for identifying the details of the intruder from the distributed set of databases and activates the output device to generate personalized warning to warn off the intruder to stay away from the vehicle.

Another object of the present invention is to provide the vehicle security system wherein the bi-directional communication unit communicates the processed images in real time over the communication network. Further, the bi-directional communication unit sends notification over the communication network on receiving the intruder signal from the intruder module.

Another object of the present invention is to provide the vehicle security system wherein the wherein the plurality of modules further comprising a classifier module to classify the intruder into human and animals. Further, the classifier module is coupled to the intruder module to activate the output device if the intruder is human. Further, the intruder module crosschecks the image of the intruder with law enforcement databases.

Another object of the present invention is to provide the vehicle security system with one or more autonomous vehicles coupled to the server to follow the vehicle on receiving intruder signals from the server. The server further activates cameras of other registered vehicles to retrieve digital data to identify the approaching object.

Another object of the present invention is to provide the vehicle security system with a sensor coupled to the processing unit to detect threat level on the vehicle, wherein the memory unit stores a minimum threat level. Further, the processing unit activates the output device to generate output signals if the threat level exceeds the minimum threat level.

Another object of the present invention is to provide the vehicle security system, wherein the registration module registers users for communication. Further, the intruder module activates the bi-directional communication unit to notify other registered users.

Another object of the present invention is to provide the vehicle security system with a rechargeable battery to power the camera, the memory unit, the processing unit, the output device and the bi-directional communication unit. Further, the server is either attached to the vehicle or is at cloud.

### BRIEF DESCRIPTION OF DRAWINGS

These and other features and advantages will be better and completely understood by referring to the following detailed description of presently preferred example embodiments in accordance with the drawings, of which:

FIG. 1 is a block diagram of a vehicle security system for alerting on identifying an intrusion on a vehicle by an intruder in accordance with an embodiment of the present invention;

FIG. 2 illustrates a schematic view of a classifier module in accordance with another embodiment of the present invention; and

FIG. 3 illustrates a schematic view of an autonomous vehicle tracking the vehicle and communicating with a server.

### DETAILED DESCRIPTION OF DRAWINGS

While this technology is illustrated and described in a preferred embodiment, a vehicle security system for alerting on identifying an intrusion on a vehicle by an intruder may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

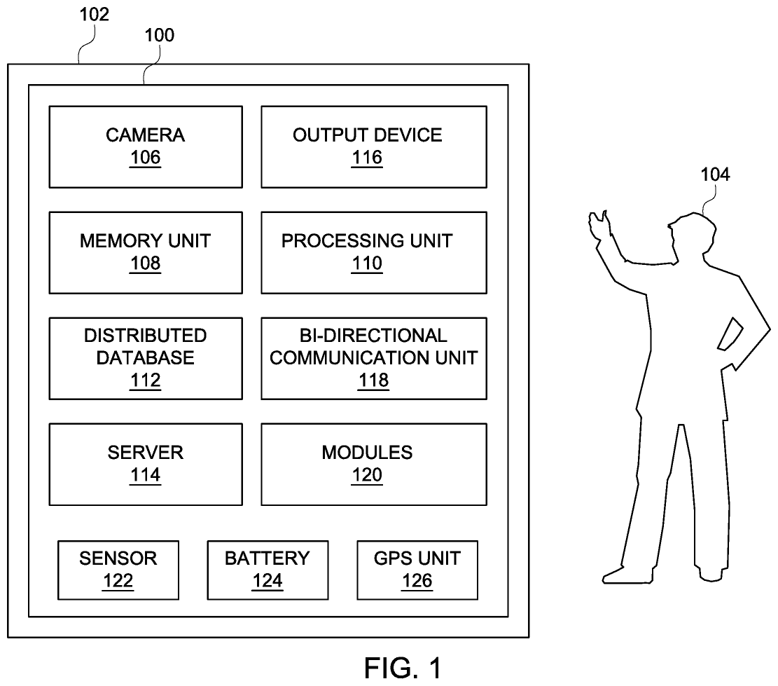

FIG. 1 is a block diagram of a vehicle security system 100 for alerting on identifying an intrusion on a vehicle 102 by an intruder 104 in accordance with a preferred embodiment of the present invention. The vehicle security system 100 includes at least one camera 106, a memory unit 108, a processing unit 110, a distributed set of databases 112, a server 114, an output device 116, and a bi-directional communication unit 118.

The camera 106 is attached to the vehicle 102 configured to capture images. The camera 106 capture images of approaching objects. Examples of objects include but not limited to animals, human, vehicles, equipment etc. Examples of the camera 106 include HD camera, infra-red camera, wide angle camera, night vision cameras, multi-spectral cameras etc.

The memory unit 108 stores images captured by the camera 106. Examples of the memory unit 108 include but not limited to flash memory, disk-type memory, random access memory, read only memory etc. Examples of the vehicle 102 include but not limited to motorbikes, electric bikes, bicycles, e-bikes, scooters, e-scooters and other similar micro mobility vehicles.

The processing unit 110 is operably connected to the camera 106 and the memory unit 108 to process the images. Examples of the processing unit 110 includes but not limited to microcontroller, controllers, processors, micro-computers, RaspberryPI etc.

The distributed set of databases 112 stores images and details of people. Examples of the distributed set of databases 112 includes but not limited to LinkedIn, Twitter, Instagram, Facebook and other social databases. The distributed set of databases 112 may also be linked with other existing law enforcement databases such as Facial Images National Database (FIND), Statewide Network of Agency Photos (SNAP), Michigan Criminal Justice Information Network (MiCJIN) etc.

The server 114 is operably connected to the processing unit 110 via the bi-directional communication unit 118, and the distributed set of databases 112. Further, the server 114 stores authorized person images and a plurality of modules 120. In a preferred embodiment of the present invention, the server 114 is located at cloud. Alternatively, the server 114 may be located on the vehicle 102.

The output device 116 is operably connected to the processing unit 110 to produce output signals on detecting the intruder. Examples of the output device 116 include but not limited to speakers to generate sound, lighting unit to illuminate light, vibrators to generate vibrations etc. In another embodiment of the present invention, the output device 116 is directly operated by the server 114 i.e. the server 114 may trigger or disable triggering of the output device 116.

The bi-directional communication unit 118 is operably connected to the processing unit 110 to communicate processed images over a communication network. Further, the processing unit 110 receives commands from the server 114 via the bi-directional communication unit 118.

In another preferred embodiment of the present invention, the bi-directional communication unit 118 communicates the processed images in real time over the communication network. For exemplary purposes, the unit 118 sends processed images to the communication device (e.g. smartphones, smart devices) of owner of the vehicle, and law enforcement departments. Examples of the bi-directional communication unit 118 includes but not limited to wi-fi device, Bluetooth, GSM unit and other similar wireless communication devices.

In another preferred embodiment of the present invention, the bi-directional communication unit 118 further sends notifications over the communication network on receiving intruder signal from the intruder module. For exemplary purposes, the bi-directional communication unit 118 sends notifications to vehicle owner, other registered users in the vicinity, local police etc. Examples of notifications include but not limited to SMS, calls, MMS, video clips, social media hashtags and other modes of communications etc.

For exemplary purposes, the notifications may include messages like “The black e-bike next to the trash with the lights flashing is being stolen . . . ” It would be readily apparent to those skilled in the art that various types of bi-directional communication unit 118, and notifications may be envisioned without deviating from the scope of the present invention.

The plurality of modules 120 are processed by the server 114. The plurality of modules 120 includes a registration module, a verification module, an intruder module, and a personalized warning module. The registration module allows users to register images of person authorized to access the vehicle 102 and for registering vehicles.

In another embodiment, the registration module allows registration module to register users for communication over the communication network. The registration module ensure that registered users are informed about intrusions in the vicinity. The verification module compares the image of the intruder 104 received from the camera 106 with the registered images. If the image is verified, no warning signal is produced by the output device 116.

The intruder module generates intruder signal by activating the output device to generate output signals if the intruder is not one of the registered person. The personalized warning module identifies the details of the intruder 104 from the distributed set of databases 112. The personalized warning module activates the output device 116 to generate personalized warning to warn off the intruder 104 to stay away from the vehicle 102.

For exemplary purposes, the personal warning may include message like “Alex, you have been detected loitering around this car and your image has been uploaded to the Internet. Please be aware that in this state it is a felony to steal, vandalize or interfere with a bike . . . ”. The name is identified through the distributed set of databases. The messages may also include their address details.

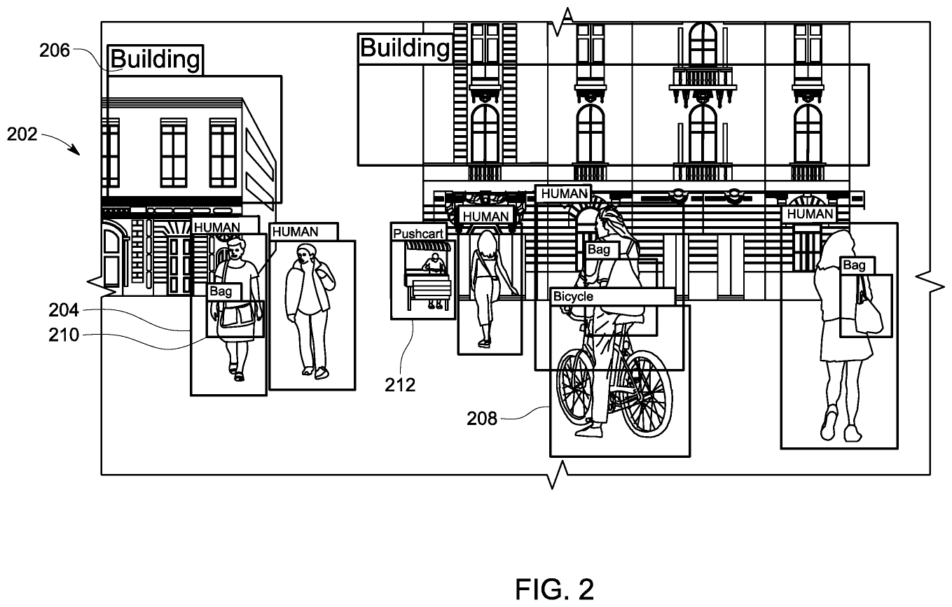

In another preferred embodiment of the present invention, the plurality of modules 120 further includes a classifier module operably coupled to the camera to classify the intruder into human, and other moving objects. The classifier module is explained in detail in conjunction with FIG. 2 of the present invention.

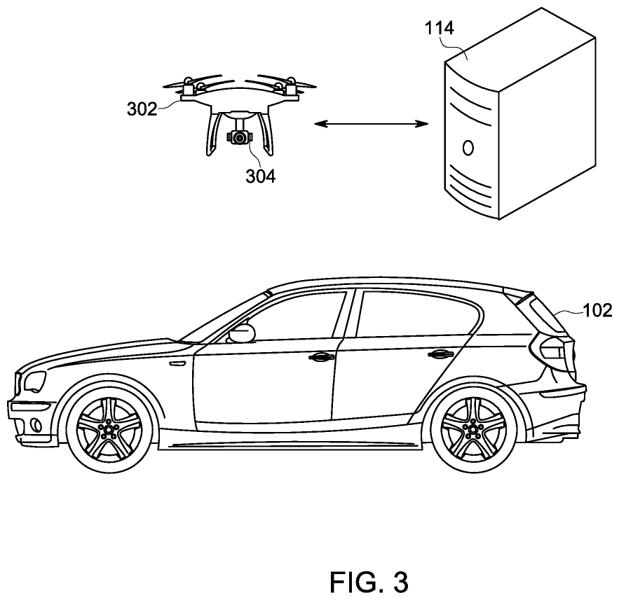

In another preferred embodiment of the present invention, the vehicle security system 100 includes one or more autonomous vehicles (302, shown in FIG. 3) and a GPS unit to send real time location of the vehicle to the server. The autonomous vehicles (302, shown in FIG. 3) are explained in detail in conjunction with FIG. 3 of the present invention.

In another embodiment of the present invention, the server 114 activates cameras of other registered vehicles to retrieve digital data to identify the approaching object 104. In another embodiment of the present invention, the server 114 is programmed with machine learning to train the algorithms to better recognize humans, and human faces.

In another embodiment of the present invention, the vehicle security system 100 includes a sensor is coupled to the processing unit 110 to detect threat level on the vehicle 102. The memory unit 108 stores a minimum threat level. Further, the processing unit 110 activates the output device 116 to generate output signals if the threat level exceeds the minimum threat level, based on the data retrieved from the sensor.

For exemplary purposes, the processing unit detects the type of threat carried by the intruder. The processing unit 110 detects if the intruder is carrying a weapon, gadgets to open the vehicle in an unauthorized way etc. If the threat level exceeds the minimum threat level, then the output device 116 generates the warning.

In another exemplary embodiment of the present invention, the sensor detects any unauthorized movement of the vehicle using the sensor (e.g. motion sensor, accelerometer, gyrometers etc.) and sends notification to the registered user about the unauthorized movement of the vehicle. Examples of sensors include but not limited to passive infrared sensors, sonar sensors, lidar sensors, microphones, accelerometers, tamper detection sensors, pressure sensors, multi-special cameras.

In another preferred embodiment of the present invention, the vehicle security system 100 includes a rechargeable battery to power the camera 106, the memory unit 108, the processing unit 110, the distributed set of databases 112, the server 114, the output device 116, and the bi-directional communication unit 118. Examples of rechargeable battery include but not limited to lithium, solar cell, nickel-metal hydride, nickel-cadium, lead-acid batteries etc.

FIG. 2 illustrates a schematic view of a classifier module 202 in accordance with another embodiment of the present invention. The classifier module 202 classifies the object. For example, the classifications of the object are done in building 206, bicycle 208, human 204, bag 210, pushcart 212 etc.

In another embodiment of the present invention, the classifier module 202 is programmed with machine learning to automatically learn and add about classifications without being explicitly programmed. It would be readily apparent to those skilled in the art that various types of classifications may be envisioned without deviating from the scope of the present invention.

In an embodiment, the classifier module 202 is programmed to classify the humans 204 approaching the vehicle. For example, the classifier module 202 classifies the human i.e. whether the human is carrying a weapon, wearing a mask to cover the face, carrying a tool to open the vehicle in an unauthorized manner.

FIG. 3 illustrates a schematic view of an autonomous vehicle 302 tracking the vehicle 102 and communicating with a server 114. The autonomous vehicle 302 is activated on receiving alert signals from the server 114. The autonomous vehicle 302 includes a camera 304 to send digital data (images or videos) of the vehicle 102 to the server 114.

Examples of autonomous vehicle 302 include but not limited to robots, marine devices, UAVs (unmanned aerial vehicles), drones etc. It would be readily apparent to those skilled in the art that various types of autonomous vehicle 302 may be envisioned without deviating from the scope of the present invention.

Embodiments of this invention are described herein. Variations of those embodiments may become apparent to those having ordinary skill in the art upon reading the foregoing description. The inventors expect that skilled artisans will employ such variations as appropriate, and the inventors intend for the invention to be practiced other than as specifically described herein. Accordingly, this invention includes all modifications and equivalents of the subject matter recited in the claims appended hereto as permitted by applicable law. Moreover, any combination of the above-described elements in all possible variations hereof is encompassed by the invention unless otherwise indicated herein or otherwise clearly contradicted by context.

While the disclosure above sets forth the principles of the present invention, with the examples given for illustration only, one should realize that the use of the present invention includes all usual variations, adaptations and/or modifications within the scope of the claims attached as well as equivalents thereof.

The use of the terms “a” and “an” and “the” and similar referents in the context of describing an invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., “including, but not limited to,”) unless otherwise noted.

Those skilled in the art will appreciate from the foregoing that various adaptations and modifications of the just described embodiments can be configured without departing from the scope and spirit of the invention. Therefore, it is to be understood that, within the scope of the appended claims, the invention may be practiced other than as specifically described herein.

1. A vehicle security system for alerting on identifying an intrusion on a vehicle by an intruder, the vehicle security system comprising:
at least one camera attached to the vehicle configured to capture images;
a memory unit to store images captured by the camera, a plurality of modules and authorized person images;
a processing unit operably connected to the camera and the memory unit to process the images and the plurality of modules,
a distributed set of databases coupled to the processing unit for storing images and details of people;
an output device operably connected to the processing unit to produce output signals on detecting the intruder;
a bi-directional communication unit operably connected to the processing unit and the distributed set of databases to communicate processed images over a communication network, further the processing unit receives commands via the bi-directional communication unit;
wherein the plurality of modules processed by the processing unit, the plurality of modules comprising:
a registration module for registering images of persons authorized to access the vehicle and for registering vehicles;
a verification module compares the image of the intruder received from the camera with the registered images;
an intruder module generates intruder signals by activating the output device to generate output signals if the intruder is not one of the registered persons; and
a personalized warning module identifies the details of the intruder from the distributed set of databases, further the personalized warning module activates the output device to generate personalized warnings to warn off the intruder to stay away from the vehicle.

2. The vehicle security system according to claim 1, wherein the bi-directional communication unit communicates the processed images in real time over the communication network.

3. The vehicle security system according to claim 1, wherein the plurality of modules further comprising a classifier module operably coupled to the camera to classify the intruder into human and other moving objects, further the classifier module is coupled to the intruder module to activate the output device if the intruder is human.

4. The vehicle security system according to claim 1, wherein the bi-directional communication unit sends notifications over the communication network on receiving the intruder signal from the intruder module.

5. The vehicle security system according to claim 1, wherein the intruder module crosschecks the image of the intruder with law enforcement databases.

6. The vehicle security system according to claim 1 further comprising a server to communicate data with the processing unit, further the server communicates over the communication network.

7. The vehicle security system according to claim 1, wherein the server receives intruder signals from the processing unit.

8. The vehicle security system according to claim 7 further comprising one or more autonomous vehicles to follow the vehicle on receiving intruder signals from the server, wherein the autonomous vehicles send digital data over the communication network to the server.

9. The vehicle security system according to claim 7 wherein the server activates cameras of other registered vehicles to retrieve digital data to identify the approaching object.

10. The vehicle security system according to claim 1 further comprising a sensor coupled to the processing unit to detect threat level on the vehicle, wherein the memory unit stores a minimum threat level, and wherein the processing unit activates the output device to generate output signals if the threat level exceeds the minimum threat level.

11. The vehicle security system according to claim 1 wherein the registration module to register users for communication over the communication network.

12. The vehicle security system according to claim 11 wherein the intruder module activates the bi-directional communication unit to notify other registered users.

13. The vehicle security system according to claim 1 further comprising a rechargeable battery to power the camera, the memory unit, the processing unit, the output device and the bi-directional communication unit.

14. The vehicle security system according to claim 6 wherein the server is attached to the vehicle.

15. The vehicle security system according to claim 6 wherein the server is located at cloud.

16. The vehicle security system according to claim 1 further comprising a GPS unit to send real time location of the vehicle to the processing unit.
